(19) United States
(12) Patent Application Publication
(10) Pub. No.: US 2005/0111380 A1
(43) Pub. Date: May 26, 2005

(54) Method, apparatus and system for mobile nodes to dynamically discover configuration information

(76) Inventors: Farid Adrangi, Lake Oswego, OR (US); Ranjit S. Narjala, Hillsboro, OR (US); Michael B. Andrews, Beaverton, OR (US)

Correspondence Address: INTEL CORPORATION, P.O. BOX 5326, SANTA CLARA, CA, 95056-5326, US

(21) Appl. No.: 10/723,813

(22) Filed: Nov. 25, 2003

(51) Int. Cl. H04L 12/28

(52) U.S. Cl. 370/254

(57) ABSTRACT

A method, apparatus and system enable a mobile node to dynamically discover configuration information while roaming. In one embodiment, Dynamic Host Control Protocol (“DHCP”) servers may respond to a mobile node DHCP request with information pertaining to home agents. The mobile node may register with the home agent and receive a registration reply. Based on extensions within the registration reply, the mobile node may determine whether it is roaming on an internal or an external network. The mobile node may then utilize and/or store other information contained within the registration reply extensions to ensure that the mobile node is registered with the appropriate home agent.

### FIELD

The present invention relates to the field of mobile computing, and, more particularly to a method, apparatus and system for mobile nodes to dynamically discover configuration information while roaming.

### BACKGROUND

Use of mobile computing devices (hereafter “mobile nodes”) such as laptops, notebook computers, personal digital assistants (“PDAs”) and cellular telephones is becoming increasingly popular today. These mobile nodes enable users to move from one location to another (“roam”), while continuing to maintain their connectivity to the same network. Given its increasing popularity, it is unsurprising that most corporate (“enterprise”) networks today attempt to facilitate fast and secure mobile computing.

In order to roam freely, networks typically conform to one or more industry-wide mobile IP standards. More specifically, the Internet Engineering Task Force (“IETF”) has promulgated roaming standards (Mobile IPv4, IETF RFC 3344, August 2002, hereafter “Mobile IPv4,” and Mobile IPv6, IETF Mobile IPv6, Internet Draft draft-ietf-mobileip-ipv6-24.txt (Work In Progress), June 2003, hereafter “Mobile IPv6”) to enable mobile node users to move from one location to another while continuing to maintain their connectivity to the same network.

### BRIEF DESCRIPTION OF THE DRAWINGS

The present invention is illustrated by way of example and not limitation in the figures of the accompanying drawings in which like references indicate similar elements, and in which:

FIG. 1 illustrates a known corporate intranet structure;

FIG. 2 illustrates a known enterprise network topology;

FIG. 3 illustrates a network topology according to the Dual HA Solution;

FIG. 4 illustrates conceptually the multiple domains a mobile node may traverse;

FIG. 5 illustrates embodiments of the present invention; and

FIG. 6 is a flow chart illustrating embodiments of the present invention.

### DETAILED DESCRIPTION

Embodiments of the present invention provide a method, apparatus and system for mobile nodes to dynamically discover configuration information while roaming. Reference in the specification to “one embodiment” or “an embodiment” of the present invention means that a particular feature, structure or characteristic described in connection with the embodiment is included in at least one embodiment of the present invention. Thus, the appearances of the phrases “in one embodiment,” “according to one embodiment” or the like appearing in various places throughout the specification are not necessarily all referring to the same embodiment.

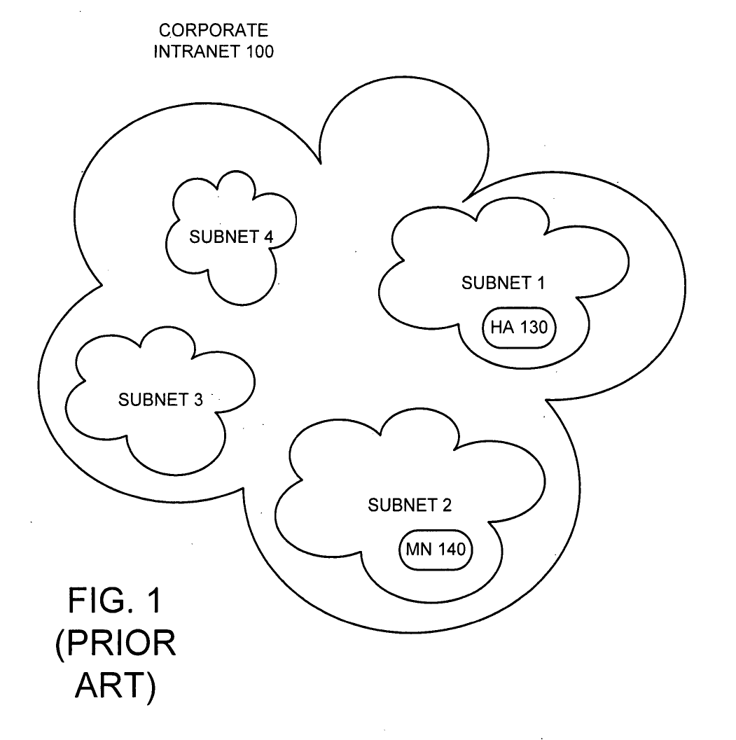

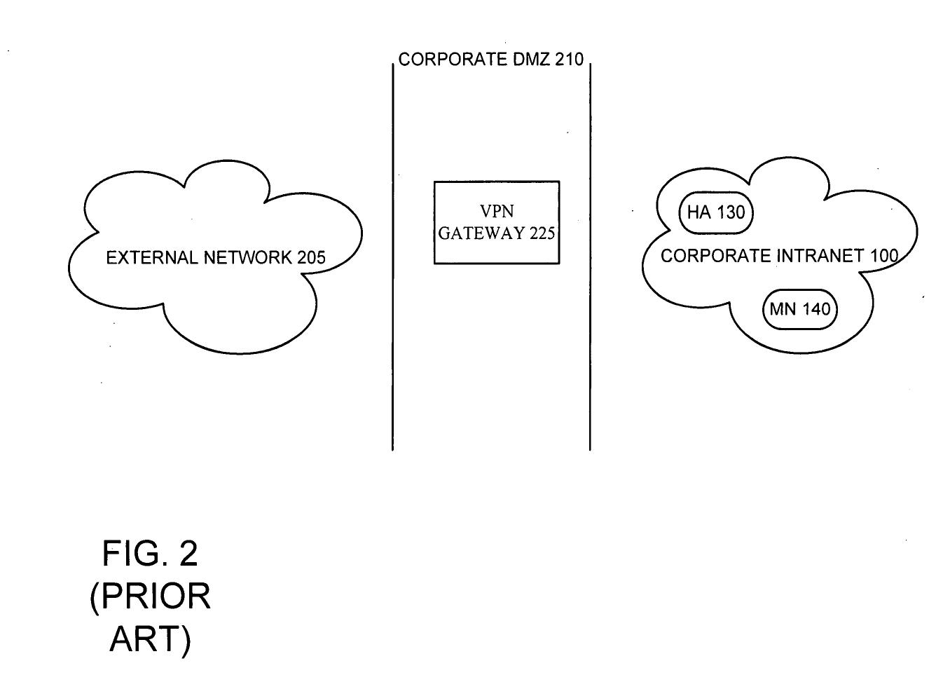

In order to facilitate understanding of embodiments of the present invention, the FIG. 1 and FIG. 2 describe typical network topologies and roaming scenarios. Specifically, FIG. 1 illustrates a known corporate intranet (“Corporate Intranet 100”) structure. Corporate Intranet 100 may include both wired and wireless networks and may comprise multiple subnets. A subnet refers to a portion of an organization's network interconnected to other subnets by a routing element. Subnets are well known to those of ordinary skill in the art and further description thereof is omitted herein.

Mobile nodes that conform to Mobile IPv4 standards today may roam freely across subnets within Corporate Intranet 100. Thus, for example, when a mobile node (“MN 140”) exits its home subnet, it may continue to maintain its current transport connections and constant reachability in one of two ways. In the first scenario, MN 140 may register with a home agent (“HA 130”) when it exits its home subnet. During the registration process, MN 140 informs HA 130 of MN 140's “care-of address” (hereafter “COA”), namely MN 140's address on its new subnet. HA 130 thereafter intercepts all IP packets addressed to MN 140 and reroutes the packets to MN 140's COA. As MN 140 moves from one subnet to another, MN 140 may obtain new COAs via Dynamic Host Configuration Protocol (“DHCP”) or other similar protocols. To ensure that HA 130 is able to properly route packets to MN 140, MN 140 must continuously update HA 130 with its new COA as it roams on Corporate Intranet 100.

Corporate Intranet 100 may also be coupled to an external network, such as the Internet, and MN 140 may roam between Corporate Intranet 100 and the external network. FIG. 2 illustrates a known network topology today, comprising Corporate Intranet 100, separated from an external network (“External Network 205”) by a corporate demilitarized zone 210 (“Corporate DMZ 210”). Corporate DMZ 210 is well known to those of ordinary skill in the art and further description of such is omitted herein. Similar to Corporate Intranet 100, External Network 205 may also include both wired and wireless networks and comprise multiple subnets. For security purposes, many network topologies are likely to include security gateways such as Virtual Private Network (“VPN”) gateways (collectively illustrated in FIG. 2 as “VPN Gateway 225”) that separate Corporate Intranet 100 from External Network 205. VPN Gateway 225 may be configured to provide a secure means of communication between nodes on Corporate Intranet 100 and nodes on External Network 205. VPN gateways are well known to those of ordinary skill in the art and further description thereof is omitted herein.

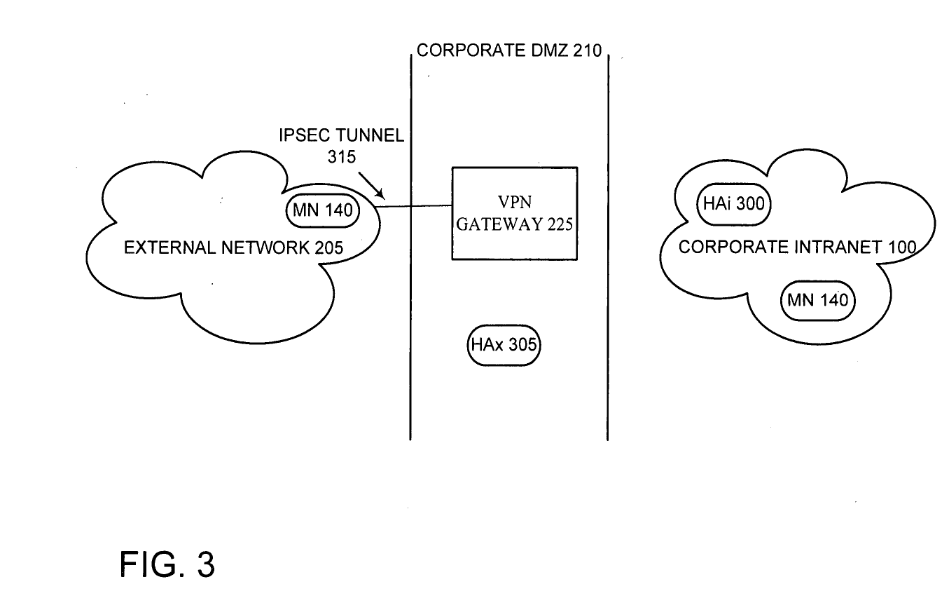

The presence of VPN Gateway 225 introduces a layer of complexity when MN 140 attempts to roam between Corporate Intranet 100 and External Network 205. One proposed solution to address the roaming problems that arise in this scenario is described in “Mobile IPv4 Traversal Across IPsec-Based VPN Gateways,” Internet Draft draft-ietf-mobileip-vpn-problem-solution-02.txt (Work In Progress), December 2002 (hereafter “Dual HA Solution”). According to the Dual HA Solution, MN 140 may register with two home agents when the MN roams on External Network 205 and wants to access resources inside Corporate Intranet 100 while maintaining its current transport sessions. FIG. 3 illustrates a network topology according to the Dual HA Solution. Specifically, as illustrated, the network topology may include at least two home agents, one (or more) located on Corporate Intranet 100 (“HAi 300”) and the other located external to Corporate Intranet 100 (“HAx 305”). “External” to Corporate Intranet 100 may include locations within Corporate DMZ 210 or on External Network 205. For the purposes of explanation, the following description assumes that HAx 305 is located within Corporate DMZ 210.

When MN 140 roams from Corporate Intranet 100 to External Network 205, MN 140 first registers with HAx 305, establishes an IP Security (“IPSec”) tunnel (“IPSec Tunnel 315”) to VPN Gateway 225 and registers (via IPSec Tunnel 315) with HAi 300. Thereafter, MN 140 may apply IPSec security protocols to all IP packets it transmits, and send these packets securely to nodes on Corporate Intranet 100 via IPSec Tunnel 315 and vice versa.

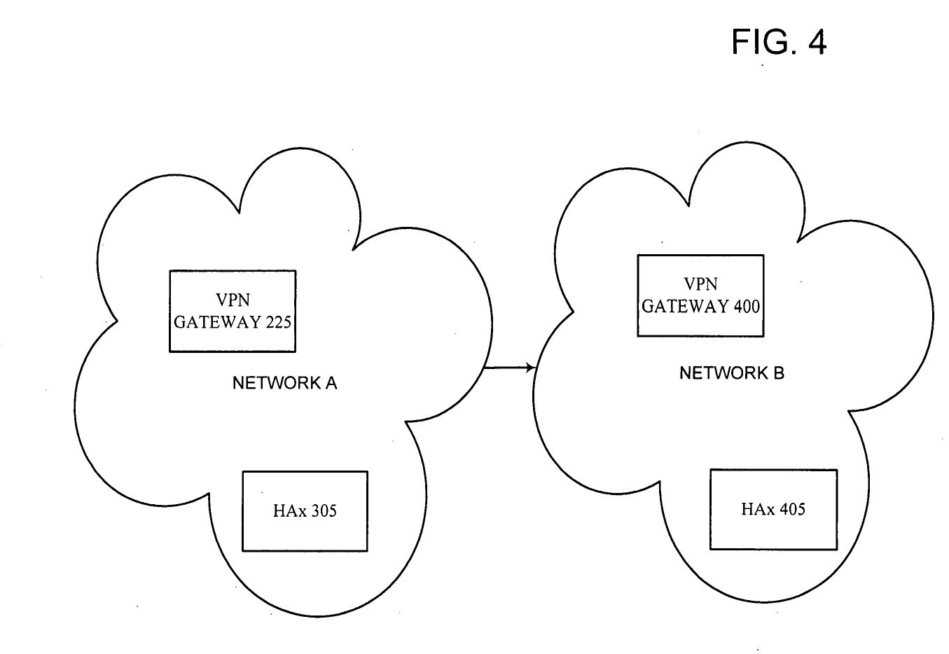

The Dual HA Solution described above presumes that MN 140 knows various configuration details, e.g., the addresses for HAi 300, HAx 305 and VPN Gateway 225. The solution also assumes that MN 140 is roaming within a single network served by VPN Gateway 225 and that all these configuration details are static. MN 140 may in fact roam from a first network (e.g., Network A) to a different network (e.g., “Network B”) having a new VPN gateway. This scenario is illustrated conceptually in FIG. 4. In this scenario, MN 140 may roam from Network A to Network B, and if so, MN 140 may have to be reconfigured with information pertaining to the new VPN gateway (“VPN Gateway 400”) and new HAx (“HAx 405”) in Network B. Additionally, it may prove to be inefficient for MN 140 to register with HAi 300 on Network A while roaming on Network B. Therefore, MN 140 may also have to be reconfigured with a new home agent (HAi) on Network B. There is currently no methodology by which MN 140 may dynamically identify a home agent.

According to embodiments of the present invention, MN 140 may be configured with a set of static information pertaining to its default internal and external home agents, and a default VPN gateway address. While roaming, however, this static information may be overridden by updated information obtained dynamically according to embodiments of the present invention. More specifically, while roaming, MN 140 may request and obtain a COA from a DHCP server. According to one embodiment, the DHCP server may also provide MN 140 with a home agent address. MN 140 may attempt to register with this home agent address, and based on information received from registration reply extensions, determine dynamically whether it is on Corporate Network 100 or External Network 205. MN 140 may then utilize additional information received in the registration reply extension to complete registration with the appropriate home agent, if necessary.

According to one embodiment, an “Internal Registration Reply Extension” (i.e., reply to registration request to an internal home agent) and an “External Registration Reply Extension” (i.e., reply to registration request to an external home agent) may be added to the registration reply extensions currently provided by home agents. The details of registration reply extensions are well known to those of ordinary skill in the art and further description thereof is omitted herein in order not to unnecessarily obscure embodiments of the present invention.

The following is a summary of embodiments of the present invention. When it exits its home subnet, MN 140 may request and obtain a COA address from a DHCP server. MN 140 may also receive a home agent address in the DHCP reply. MN 140 may attempt to register the COA with the home agent identified in the DHCP reply and receive a registration reply from the home agent. The registration reply may contain at least one registration reply extension, which MN 140 may examine to determine if it is on Corporate Intranet 100 or External Network 205. If it is an Internal Registration Reply Extension, i.e., MN 140 registered with an internal home agent on Corporate Intranet 100, the Internal Registration Reply Extension may contain one or more pairs of HAx and VPN gateway addresses for the domain. MN 140 may store these addresses for future use. Alternatively, if the extension is an External Registration Reply Extension, MN 140 may conclude that it is registered with an external home agent. If so, MN 140 may still have to register with an internal home agent. Since the External Registration Reply Extension may also contain an address for VPN Gateway 225 and one or more internal home agents, MN 140 may proceed to establish an IPSec tunnel with VPN Gateway 225 and then register with a home agent on Corporate Intranet 100. In one embodiment, MN 140 registers with the internal home agent it previously registered with rather than the home agent provided in the External Registration Reply Extension.

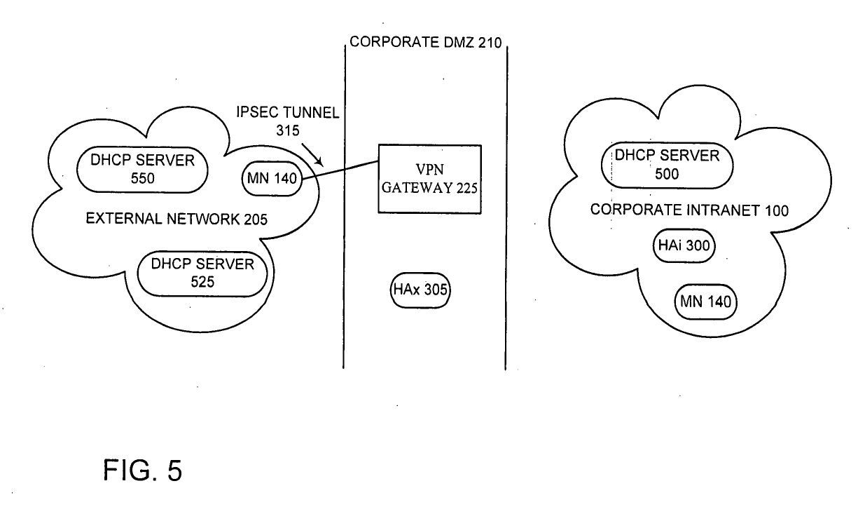

The following roaming scenarios describe various embodiments with respect to FIG. 5. More specifically, the following six scenarios are described in further detail, but embodiments of the invention are not so limited: (i) Scenario 1 describes roaming within Corporate Intranet 100; (ii) Scenario 2 describes roaming from Corporate Intranet 100 to External Network 205 managed by the same administrator as Corporate Intranet 100 (“System Administrator”); (iii) Scenario 3 describes starting up on External Network 205 managed by the System Administrator; (iv) Scenario 4 describes roaming from Corporate Intranet 100 to External Network 205 where External Network 205 is a hotspot managed by an Internet Service Vendor (“ISV”); (v) Scenario 5 describes starting up on External Network 205 where External Network 205 is a hotspot managed by an ISV; and (vi) Scenario 6 describes roaming from External Network 205 back to Corporate Network 100.

In Scenario 1, MN 140 may roam within Corporate Intranet 100, i.e. roam across subnets within a corporate network. According to one embodiment, when MN 140 first exits its home subnet, it is associated with its default internal home agent, HAi 300. Upon exiting its home subnet, MN 140 may acquire a COA from DHCP Server 500 (managed by System Administrator). From the DHCP reply, MN 140 may also obtain an internal home agent address. MN 140 may, however, attempt to register with the HA it was originally associated with on its home subnet, i.e., HAi 300. When attempting to register, MN 140 is unaware whether it is still within Corporate Intranet 100, but since the registration reply from HAi 300 may contain an Internal Registration Reply Extension, MN 140 may confirm that it is still on Corporate Intranet 100. If the registration with HAi 300 is unsuccessful, MN 140 may attempt to register with the HA it obtained from the DHCP reply. The Internal Registration Reply Extension may include VPN Gateway 225's external address and a default address for an external home agent (HAx 305). MN 140 may store these addresses for future use, i.e., VPN Gateway 225 address and HAx 300's address may not be utilized until MN 140 traverses VPN Gateway 225 to roam on External Network 205.

In Scenario 2, MN 140 may exit Corporate Intranet 100, i.e., roam from Corporate Intranet 100 to External Network 205, where External Network 205 is a Wireless Local Area Network (“WLAN”) managed by the System Administrator. When MN 140 initially exits Corporate Intranet 100, it may only realize that it has changed subnets and not know that it is now on External Network 205. Invisible to MN 140, however, when it sends out a request for a new COA, in one embodiment, instead of going to DHCP Server 500, the request may be serviced by DHCP Server 525. Since-Corporate Intranet 100 and External Network 205 are managed by the same entity, DHCP Server 500 and DHCP Server 525 may be configured consistently, to provide MN 140 with the same information. Based on the DHCP reply from DHCP Server 525, MN 140 may obtain a new HA address, namely the address for the external home agent (HAx 305). Since MN 140 still does not know that it has moved to External Network 205, it may not recognize the address for HAx 305. MN 140 may therefore send the registration request to the HA it was previously registered with (i.e., HAi 300). The registration request will fail because HAi 300 resides on Corporate Intranet 100, protected by Corporate DMZ 210. HAi 300 may therefore not be directly reachable from External Network 205 and MN 140 may receive an error message such as “ICMP destination unreachable.”

Since it cannot register directly with HAi 300, MN 140 may then register with the HA address obtained from the DHCP reply (i.e., HAx 305). Upon successful completion of this registration request, MN 140 may obtain from the External Registration Reply Extension an address for VPN Gateway 225 and one ore more HAi addresses. Now, as described previously in the Dual HA Solution, MN 140 may establish IPSec Tunnel 315 to VPN Gateway 225 and register (via IPSec Tunnel 315) with HAi 300. Thereafter, MN 140 may apply IPSec security protocols to all IP packets it transmits, and send these packets securely to nodes on Corporate Intranet 100 via IPSec Tunnel 315 and vice versa. In one embodiment, although the External Registration Reply Extension may also contain one or more HAi addresses, MN 140 already knows the address for its HAi and may therefore ignore the HAi addresses.

In Scenario 3, instead of roaming from Corporate Intranet 100 to External Network 205, MN 140 may start up on External Network 205 (managed by the System Administrator). If MN 140 desires to access resources on Corporate Intranet 100, it may attempt to register with its default home agent, HAi 300. Since HAi 300 is protected by Corporate DMZ 210, however, the registration will fail. According to one embodiment of the present invention, MN 140 may then obtain an address for HAx 305 from DHCP Server 525 and register with HAx 305. In the External Registration Reply Extension, MN 140 may also receive an address for VPN Gateway 225 and one or more HAi addresses. MN 140 may then establish IPSec Tunnel 315 to VPN Gateway 225 and register (via IPSec Tunnel 315) with HAi 300.

In Scenario 4, MN 140 may roam from Corporate Intranet 100 to External Network-205 where External Network 205 is a hotspot managed by an Internet Service Vendor (“ISV”). In this embodiment, MN 140 may request a new COA from the ISVs DHCP server (illustrated as “ISV DHCP Server 550”). Since ISV DHCP Server 550 may not include the same configuration information as DHCP Servers 500 and 525, however, unlike Scenario 2, the DHCP registration reply may not include a HA address. MN 140 may still attempt to register with HAi 300, but as in Scenario 2, this registration request will fail because HAi 300 resides on Corporate Intranet 100, behind DMZ 210. In one embodiment, MN 140 may instead default to registering with the HAx it originally obtained when registering with HAi 300 (i.e., the default HAx address MN 140 received when it originally registered with HAi 300 prior to exiting Corporate Intranet 100). Upon successful registration with HAx 305, MN 140 may obtain VPN Gateway 225's address from the External Registration Reply Extension and proceed as in the previous scenarios (i.e., registering with HAi 300, setting up an IPSec tunnel, etc.). In one embodiment, ISV DHCP Server 550 may include its own HA address in the DHCP reply. Upon receipt of this address, MN 140 may attempt to register with the ISV's HA, but the registration attempt will not succeed because MN 140 does not have any security association with the ISV's HA. MN 140 may then proceed to register with its default HAx 305, as described above.

In Scenario 5, MN 140 may start up on External Network 205 where External Network 205 is a hotspot managed by an ISV. In this scenario, similar to the scenario described above, MN 140 may request a new COA from ISV DHCP Server 550. Since DHCP Server 550 is not managed by System Administrator, the registration reply may not include a new HA address. MN 140 may then register with its default external home agent, HAx 305. Upon successful registration with HAx 305, MN 140 may obtain VPN Gateway 225's address from the External Registration Reply Extension and one or more HAi addresses. MN 140 may use one of the HAi addresses it obtains and proceed to register with that home agent.

In Scenario 6, MN 140 may roam from External Network 205 to Corporate Intranet 100. In this scenario, MN 140 may realize that it has changed subnets without realizing that it has roamed back to Corporate Intranet 100. MN 140 may request a COA from DHCP Server 500, and from the DHCP reply, MN 140 may also obtain a default internal home agent address (HAi 300 address). MN 140 may however still attempt to register with HAx 305 because it is not aware that it has moved across Corporate DMZ 210 to Corporate Intranet 100, i.e., MN 140 assumes it is still roaming on External Network 205. The registration will not be successful because, in one embodiment, Corporate DMZ 210 prevents HAx 305 from being directly reachable from Corporate Intranet 100. In an alternate embodiment, HAx 305 may be directly reachable, but the registration reply may not be able to traverse Corporate DMZ 210. In either embodiment, the registration process may fail. Thus, according to one embodiment of the present invention, MN 140 may then attempt to register with the HAi 300 based on the address it received from DHCP Server 500. If this registration request succeeds, then MN 140 may confirm that it is once again inside Corporate Intranet 100. MN 140 may therefore proceed to tear down any existing IPSec tunnel(s) and continue to roam within Corporate Intranet 100 without concern for VPN Gateway 225.

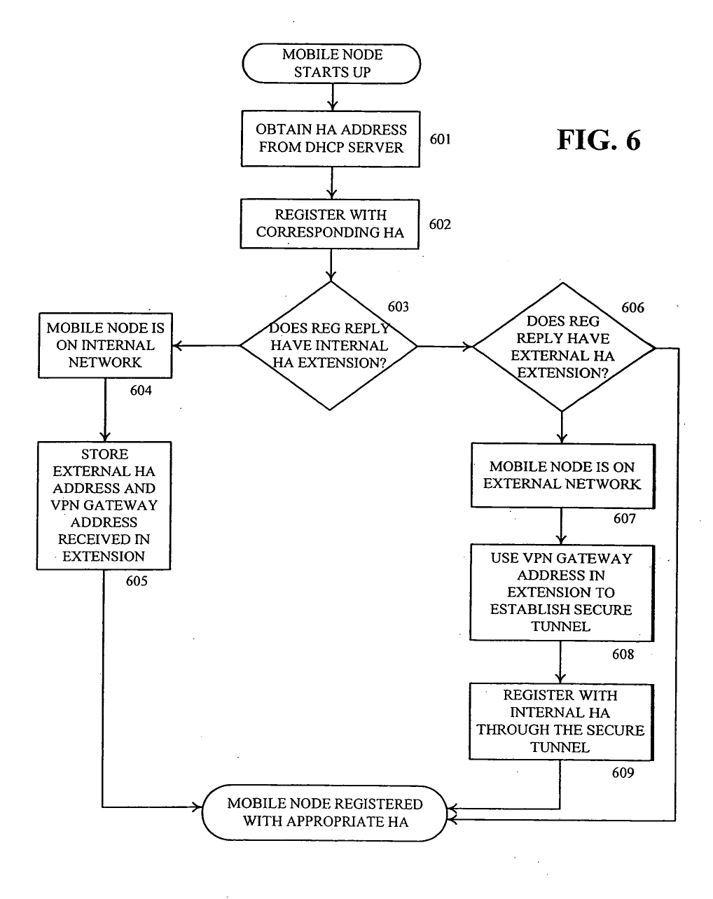

FIG. 6 is a flow chart illustrating a summary of various embodiments of the present invention. Although the following operations may be described as a sequential process, many of the operations may in fact be performed in parallel or concurrently. In addition, the order of the operations may be re-arranged without departing from the spirit of embodiments of the invention. Upon startup, MN 140 obtains a HA address via a DHCP request in 601. MN 140 registers with this HA in 602. In 603, MN 140 may examine the HA Registration Reply Extension to determine if it is an Internal Registration Reply Extension. If it is, in 604, MN 140 concludes that it is roaming within Corporate Intranet 100 and in 605, MN 140 stores the external HA address and the VPN gateway address. If, however, the Registration Reply Extension is not an Internal Registration Reply Extension, in 606, the extension is examined to determine if it is an External Registration Reply Extension. If it is, MN 140 concludes that it is roaming on External Network 205 in 607, and in 608, MN 140 may utilize the VPN gateway address in the extension to establish an IPSec (VPN) tunnel. In 609, MN 140 may register with the internal HA via the IPSec tunnel.

The mobile nodes, home agents and VPNs according to embodiments of the present invention may be implemented on a variety of data processing devices. It will be readily apparent to those of ordinary skill in the art that these data processing devices may include various types of software, and may comprise any devices capable of supporting mobile networks, including but not limited to mainframes, workstations, personal computers, laptops, portable handheld computers, PDAs and/or cellular telephones. In an embodiment, mobile nodes may comprise portable data processing systems such as laptops, handheld computing devices, personal digital assistants and/or cellular telephones. According to one embodiment, home agents and/or VPNs may comprise data processing devices such as personal computers, workstations and/or mainframe computers. In alternate embodiments, home agents and VPNs may also comprise portable data processing systems similar to those used to implement mobile nodes.

According to embodiment of the present invention, data processing devices may include various components capable of executing instructions to accomplish an embodiment of the present invention. For example, the data processing devices may include and/or be coupled to at least one machine-accessible medium. As used in this specification, a “machine” includes, but is not limited to, any data processing device with one or more processors. As used in this specification, a machine-accessible medium includes any mechanism that stores and/or transmits information in any form accessible by a data processing device, the machine-accessible medium including but not limited to, recordable/non-recordable media (such as read only memory (ROM), random access memory (RAM), magnetic disk storage media, optical storage media and flash memory devices), as well as electrical, optical, acoustical or other form of propagated signals (such as carrier waves, infrared signals and digital signals).

According to an embodiment, a data processing device may include various other well-known components such as one or more processors. The processor(s) and machine-accessible media may be communicatively coupled using a bridge/memory controller, and the processor may be capable of executing instructions stored in the machine-accessible media. The bridge/memory controller may be coupled to a graphics controller, and the graphics controller may control the output of display data on a display device. The bridge/memory controller may be coupled to one or more buses. A host bus controller such as a Universal Serial Bus (“USB”) host controller may be coupled to the bus(es) and a plurality of devices may be coupled to the USB. For example, user input devices such as a keyboard and mouse may be included in the data processing device for providing input data.

In the foregoing specification, the invention has been described with reference to specific exemplary embodiments thereof. It will, however, be appreciated that various modifications and changes may be made thereto without departing from the broader spirit and scope of the invention as set forth in the appended claims. The specification and drawings are, accordingly, to be regarded in an illustrative rather than a restrictive sense.

1. A method for dynamically configuring a mobile node, comprising:
issuing a first Dynamic Host Control Protocol (“DHCP”) request;
receiving an address for a first home agent in response to the first DHCP request;
registering with the first home agent;
examining a registration reply from the first home agent to identify an extension; and
determining from the extension whether the mobile node is on one of an internal network and an external network.

2. The method according to claim 1 wherein the first home agent is one of an internal home agent and an external home agent, and the extension includes one of an internal registration reply extension and an external registration reply extension.

3. The method according to claim 2 wherein the mobile node is on the internal network if the home agent address includes the internal registration reply extension and on the external network if the home agent address includes the external registration reply extension.

4. The method according to claim 1 further comprising receiving an address for a default Virtual Private Network (“VPN”) gateway and an address for a default home agent in response to the first DHCP request.

5. The method according to claim 4 wherein the mobile node is on the internal network and the address of the default home agent is an address of an external home agent, the method further comprising storing the address for the default VPN gateway and the address for the external home agent.

6. The method according to claim 5 further comprising:
roaming from the internal network to the external network;
issuing a second DHCP request;
receiving an address for a second home agent in response to the second DHCP request;
registering with the address for the first home agent; and
registering with the second home agent if the registration attempt to the first home agent fails.

7. The method according to claim 6 wherein the second home agent is an external home agent.

8. The method according to claim 4 wherein the mobile node is on the external network, the address for the default home agent is an address of an internal home agent, and the method further comprises establishing a secure connection with the default VPN gateway.

9. The method according to claim 8 further comprising registering the mobile node with the internal home agent on the internal network via the secure connection.

10. A system, comprising:
a mobile node capable of issuing a first Dynamic Host Control Protocol (“DHCP”) request;
a first home agent coupled to the mobile node, the first home agent capable of issuing a registration reply including an extension in response to a registration request from the mobile node;
a DHCP server coupled to the mobile node and the first home agent, the DHCP server capable of providing a DHCP reply in response to the DHCP request from the mobile node, the DHCP reply including an address for the first home agent, the mobile node further capable of registering with the first home agent, examining the registration reply from the first home agent to identify the extension and determining from the extension whether the mobile node is on one of an internal network and an external network.

11. The system according to claim 10 wherein the first home agent is one of an internal home agent and an external home agent, and the extension includes one of an internal registration reply extension and an external registration reply extension.

12. The system according to claim 1 I wherein the mobile node is on the internal network if the home agent address includes the internal registration reply extension and on the external network if the home agent address includes the external registration reply extension.

13. The system according to claim 10 wherein the DHCP reply in response to the first DHCP request further includes an address for a default Virtual Private Network (“VPN”) gateway and an address for a default home agent.

14. The system according to claim 13 wherein the mobile node is on the internal network, the address of the default home agent is an address of an external home agent and the mobile node is further capable of storing the address for the default VPN gateway and the address for the external home agent.

15. The system according to claim 14 further comprising a second home agent, and wherein:
the mobile node is capable of roaming from the internal network to the external network and issuing a second DHCP request to the DHCP server,
the DHCP server is capable of issuing an address for the second home agent in response to the second DHCP request, and
the mobile node is further capable of registering with the first home agent, and registering with the second home agent if the registration attempt to the first home agent fails.

16. The system according to claim 15 wherein the second home agent is an external home agent.

17. The system according to claim 13 wherein the mobile node is on the external network, the address for the default home agent is an address of an internal home agent, and the mobile node is further capable of establishing a secure connection with the default VPN gateway.

18. The system according to claim 17 wherein the mobile node is further capable of registering with the internal home agent on the internal network via the secure connection.

19. An article comprising a machine-accessible medium having stored thereon instructions that, when executed by a machine, cause the machine to:
issue a first Dynamic Host Control Protocol (“DHCP”) request;
receive an address for a first home agent in response to the first DHCP request;
register with the first home agent;
examine a registration reply from the first home agent to identify an extension; and
determine from the extension whether the mobile node is on one of an internal network and an external network.

20. The article according to claim 19 wherein the first home agent is one of an internal home agent and an external home agent, and the extension includes one of an internal registration reply extension and an external registration reply extension.

21. The article according to claim 20 wherein the machine is on the internal network if the home agent address includes the internal registration reply extension and on the external network if the home agent address includes the external registration reply extension.

22. The article according to claim 19 wherein the instructions, when executed by the machine, are further capable of causing the machine to receive an address for a default Virtual Private Network (“VPN”) gateway and an address for a default home agent in response to the first DHCP request.

23. The article according to claim 22 wherein the machine is on the internal network, the address of the default home agent is an address of an external home agent, and the instructions when executed by the machine, are further capable of storing the address for the default VPN gateway and the address for the external home agent.

24. The article according to claim 23 wherein the machine roams from the internal network to the external network, and the instructions, when executed by the machine, further cause the machine to:
issue a second DHCP request;
receive an address for a second home agent in response to the second DHCP request;
register with the first home agent; and
register with the second home agent if the registration attempt to the home agent fails.

25. The article according to claim 24 wherein the second home agent is an external home agent.

26. The article according to claim 22 wherein the machine is on the external network, the address for the default home agent is an address of an internal home agent, and the instructions, when executed by the machine further cause the machine to establish a secure connection with the default VPN gateway.

27. The article according to claim 26 wherein the instructions, when executed by the machine, further cause the machine to register with the internal home agent on the internal network via the secure connection.

28. A method of dynamically configuring a mobile node, comprising:
processing a registration request from the mobile node; and
issuing a registration reply in response to the registration request, the registration reply including an extension indicative of whether the mobile node is on one of an internal network and an external network.

29. The method according to claim 28 wherein issuing a registration reply further comprises registering the mobile node if the mobile node is on the internal network and rejecting the registration request from the mobile node if the mobile node is on the external network.

30. An article comprising a machine-accessible medium having stored thereon instructions that, when executed by a machine, cause the machine to:
process a registration request from a mobile node; and
issue a registration reply in response to the registration request, the registration reply including an extension indicative of whether the mobile node is on one of an internal network and an external network.

31. The article according to claim 30 wherein the instructions, when executed by the machine, further cause the machine to register the mobile node if the mobile node is on the internal network and reject the registration request from the mobile node if the mobile node is on the external network.
